(19) United States
(12) Patent Application Publication
(10) Pub. No.: US 2009/0094691 A1
(43) Pub. Date: Apr. 9, 2009

(54) Intranet client protection service

(75) Inventor: Anthony Dargis, Hunterdon County, NJ (US)

Correspondence Address: AT&T CORP., ROOM 2A207, ONE AT&T WAY, BEDMINSTER, NJ, 07921, US

(73) Assignee: AT&T Services Inc.

(21) Appl. No.: 11/906,589

(22) Filed: Oct. 3, 2007

(51) Int. Cl. G06F 21/20

(52) U.S. Cl. 726/11

(57) ABSTRACT

A system and method for protecting intranet client devices in a virtual private network are disclosed. The method includes defining one or more groups of client devices to protect from traffic emanating from an external network (e.g., Internet, a Wide Area Network (WAN), a remote subnet of an intranet, and the like), while allowing the client devices to initiate TCP sessions with servers in the outside network.

### BACKGROUND OF THE INVENTION

1. Field of the Invention

The present invention generally relates to network security, and more particularly to intranet network security services.

2. Brief Description of the Related Art

A virtual private network (VPN) is a private network that uses a public telecommunication infrastructure. Typically, VPNs utilize TCP/IP protocols that allow secure sharing of organizational information and operational information among select members, employees, or others with authorization from an organization.

Typically, VPN-based intranets use the same communication lines as the Internet, but include different security modules to restrict network access by employees, customers, and others accessing the intranet. One main difference between security in the Internet and security in an intranet is that the level of trust among clients and servers is much greater in an intranet.

For example, from the viewpoint of an intranet server, client devices on the Internet are generally considered untrusted. In an intranet configuration, however, the intranet server generally considers all intranet client devices as trusted, or in the worst case, less trusted.

This difference in security assumptions places many intranets at risk. For example, mobile devices can easily traverse the intranet to the Internet and can pose an easy path for introducing malicious code. In addition, threats to intranets commonly identified include compromised client devices and mischievous users. Compromised client devices and mischievous users can attack servers, obtain unauthorized information (intentionally or unintentionally) or attempt to propagate viruses and worms throughout the intranet.

Accordingly, there exists a need to protect client devices in an intranet while allowing the client devices to access services on the Internet.

### SUMMARY OF THE INVENTION

A system and method for protecting intranet client devices in a virtual private network are disclosed. The method includes defining one or more groups of client devices to protect from traffic emanating from an external network (e.g., Internet, a Wide Area Network (WAN), a remote subnet of an intranet, and the like), while allowing the client devices to initiate TCP sessions with servers in the outside network.

Various aspects of the system relate to configuring a customer equipment router and restricting network access to client devices attached to the router. For example, according to one aspect, a method of providing intranet client protection services includes connecting a subnetwork to an external network using a router, the subnetwork operatively coupling a client device to the external network, the subnetwork comprising a portion of an intranet, and restricting access to the client device from the external network by the router in accordance with an access control list, the access control list identifying at least one service provided on the subnetwork.

In one preferred embodiment, the external network is a wide area network.

The method also can include inspecting a data packet from the at least one client device to the external network, and allowing an inbound data packet from the external network to the at least one client device based on the inspection. In one preferred embodiment, the method also includes dropping at least one data packet at the router based on the inspection.

Preferably, the method includes determining a number of half-open active TCP sessions associated with the at least one client device, comparing the number to a threshold value, and resetting at least one of the half-open sessions based on the comparison.

Preferably, the method also includes configuring the router for stateful inspection of outbound data packets to allow return traffic for at least one TCP session initiated by the client device.

In one preferred embodiment, the method also includes providing notifications to one of a customer and service provider upon at least one device from the external network attempting to access the client device.

In yet another preferred embodiment, the method includes comparing a data packet to a digital signature representative of a malicious packet; and generating an alarm based on the comparison. The method also can include performing the comparison on inbound and outbound data traffic.

The method also can include performing the comparison either inbound or outbound relative to the router. In one preferred embodiment, the external network is an IP/MPLS backbone network and the subnetwork is operatively connected to the backbone network using the router and an access circuit.

According to another aspect, a system for providing intranet client protection services comprising a subnetwork operatively coupled to an external network using a router, the subnetwork comprising at least one client device and being an identifiable portion of an intranet, wherein the router restricts access to the at least one client device from the external network in accordance with an access control list, the access control list identifying at least one service available on the subnetwork. Preferably, the external network is a wide area network.

Preferably, the router inspects a data packet from the at least one client device to the external network and allows an inbound data packet from the external network to the at least one client device based on the inspection. In one preferred embodiment, the router drops at least one data packet based on the inspection.

In one preferred embodiment, the router determines a number of half-open active TCP sessions associated with the at least one client device, compares the number to a threshold value, and resets at least one of the half-open sessions based on the comparison. Preferably, the router is adapted for stateful inspection of outbound data packets to allow return traffic for at least one TCP session initiated by the client device.

In one preferred embodiment, the router is adapted to provide notifications to one of a customer and service provider upon at least one device from the external network attempting access to the client device. In another preferred embodiment, the router is adapted to compare a data packet to a digital signature representative of a malicious packet, and to generate an alarm based on the comparison.

Preferably, the router is adapted to perform the comparison on inbound and outbound data traffic. In one preferred embodiment, the external network is an IP/MPLS backbone network and the subnetwork is operatively connected to the backbone network using the router and an access circuit.

In some embodiments, one or more of the following advantages may be present. By allowing a customer to define a group of client devices to protect from activity originating from an outside network (e.g., a remaining portion of the customer's network or a remote subnet), client devices can be protected from the outside network and yet be allowed to initiate TCP sessions with servers in the outside network.

In addition, the present invention solves the problem of having a group of clients in an intranet being able to communicate with the rest of the network but not allowing the rest of the network to access the protected client group.

A system, as well as articles that include a machine-readable medium storing machine-readable instructions for implementing the various techniques, are disclosed.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of an exemplary enhanced virtual private network according to the present invention.

FIG. 2 is a block diagram of protected client devices accessing servers on an untrusted network.

FIG. 3 is a block diagram of untrusted client devices accessing trusted servers on a Demilitarized Zone (DMZ).

FIG. 4 is a block diagram of untrusted client devices accessing trusted servers on a virtualized DMZ.

FIG. 5 is a block diagram of a UniLink implementation according to the present invention

Like reference symbols in the various drawings indicate like elements.

### DETAILED DESCRIPTION OF THE PREFERRED EMBODIMENTS

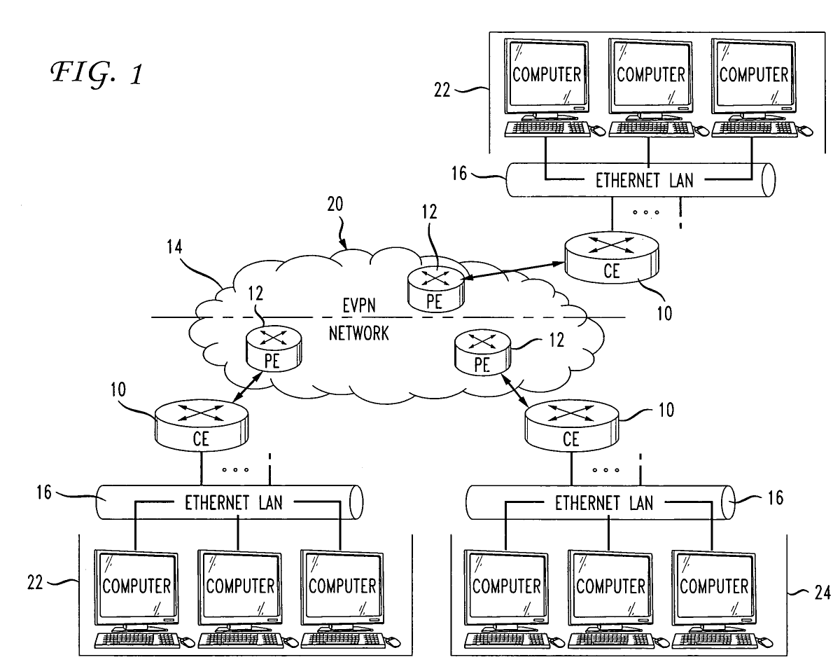

A system for providing intranet client protection services is shown in FIG. 1. The system provides intranet client protection services to devices by securely and efficiently interconnecting client devices, such as desktop computers, laptop computers, printers, and the like, in an intranet configuration. As used herein, the term intranet refers to an internal local area network that uses TCP/IP protocols like the Internet. In the preferred embodiment shown in FIG. 1, a customer equipment (CE) router 10 provided at a customer site connects the site to a provider equipment (PE) router 12 configured on an external network 14, such as a Wide Area Network (WAN). Preferably, the external network 14 connects customer subnetworks 16, which are identifiably separate parts of an intranet, using MPLS (Multi Protocol Label Switching) technology.

Preferably, the CE routers 10 of the present invention operate as a bottleneck between remote subnets of a customer's intranet to provide firewall (FW) type services. Preferably, the trust level in the intranet is different so that is possible to define a protected group and deny access to the group at the chokepoint such as the CE router 10.

In one preferred embodiment, the CE routers 10 are Cisco Integrated Services Routers (ISRs) executing an Internetworking Operating System (IOS) with advanced security features. Preferably, the CE routers 10 connect the perimeters of disparate subnetworks 16 and are configured to provide intranet security features. Intranet security is provided as a secondary security layer. Primary security is preferably implemented at gateways to public networks, such as the Internet.

In several preferred embodiments, various IOS advanced security features are configured in CE routers 10 to create the secondary security layer for intranets. For example, in one preferred embodiment, IP Security (IPsec) is configured for connecting CEs with encrypted tunnels, firewalls are configured to protect groups of outbound clients and DMZ servers, intrusion prevention services (IPS) are deployed to identify or stop malicious internal traffic, and network admission control (NAC) is configured to ensure that client machines meet defined parameters before accessing network resources. IPSec operates as a network layer by protecting and authenticating IP packets between participating IPSec devices, such as the CE routers 10.

In one preferred embodiment, CE routers 10 are configured as gateways to remote sites throughout the intranet and are configured to provide intranet security.

Preferably, the CE routers 10 of the present invention are configured to include one or more security modules. For example, in one preferred embodiment, the CE routers 10 are configured to include a firewall module and an Intrusion Prevention Services (IPS) module that each provides a level of client protection services.

Turning first to the firewall module, in one preferred embodiment, the firewall module inspects Transmission Control Protocol (TCP), User Datagram Protocol (UDP) and Internet Control Message Protocol (ICMP) packets at the CE router and bypasses ingress and egrees interfaces to allow return traffic through the CE router. Preferably, the firewall module inspects TCP sessions to ensure they are proceeding correctly. If any deviations are detected, the firewall module causes the packets to be dropped. In one preferred embodiment, the firewall module bypasses Access Control Lists (ACLs) at the ingress and egress interfaces of the CE router to allow return traffic through the CE router. The ACLs identify services available on the intranet.

Preferably, the firewall module also performs Denial of Service (DOS) detection and prevention by tracking the number and creation rate of half-open sessions. For example, in one preferred embodiment, since UDP and ICMP sessions are stateless, the firewall module approximates sessions by allowing return traffic for a short period of time (preferably 30 seconds). Furthermore, in some embodiments, applications such as File Transfer Protocol (FTP), Session Initiation Protocol (SIP), Real-time transport protocol (RTP), Hyper Text Transfer Protocol (HTTP), Simple Mail Transfer Protocol (SMTP), Trivial File Transfer Protocol (TFTP), Remote Procedure Call (RPC), and remote command (rcmd) are supported by the inspection process.

For example, in one preferred embodiment, the firewall module checks ftp and smtp sessions for malicious or illegal commands and resets the sessions if they are found.

Preferably, the firewall module configures the inspections to protect clients that initiate outbound sessions to untrusted servers and to protect servers that process inbound traffic from clients. As such, each inspection executed by the firewall module preferably operates as an independent process.

Preferably, the firewall module tracks the number of half-open TCP sessions and the rate at which they are being created. As used herein, the phrase half-open connection refers to a TCP connection that is partially open. For example, upon an originating web site (A) sending a data packet to a destination (B) host, the originating web site (A) now has a half-open session and is awaiting a response. The destination host (B) now updates its memory to indicate the incoming connection from the originating web site (A), and sends out a request to the destination host (B) to open a channel back. At this point, the destination host B now includes a “half-open” connection as it has sufficient information to receive packets, but not enough to send packets back to the originating web site. The destination host (B) is now in another state which was initiated by another device, outside of the destination host's (B's) control.

In one preferred embodiment, if the total number of half-open sessions to a host exceeds a threshold value, the firewall module drops the oldest sessions to keep the number of half-open sessions at the maximum permitted. An alert can also be sent to the management center. Advantageously, this could stop denial of service (DoS) attacks that attempt to overload servers by creating (but never completing) TCP sessions. Preferably, only a maximum number of half-open TCP-to-host connections are used for DoS protection. All other DoS parameters can be turned off by setting them to a high value. Further details of the prevention services provided by the firewall module are discussed below.

Preferably, as shown in FIG. 1, since each CE router 10 is positioned between a remote subnetwork 16 representing a logical grouping of connected network devices that are part of another, larger network, and a network cloud 20 representing connections on networks, a number of firewall services are provided by the firewall module. Those services include: TCP Pass-through protection, client group protection, demilitarized zone (DMZ) type server protection—a firewall configuration for securing local area networks, and UniLink protection. UniLink is a service that provisions separate logical channels on a single network port.

Regarding TCP Pass-through protection services, preferably, TCP sessions are inspected by the firewall module as they pass through the router 10 in either direction. Any session not following a normal progression for a session is reset. In one preferred embodiment, the firewall module places a limit on the number of allowable half-open TCP sessions.

In one preferred embodiment, referring now to client protection services, the firewall module defines groups of clients 22 either in the remote subnetwork 16 or in the network cloud 20 and protects the groups of clients from being accessed by the outside network. Preferably, a separate Ethernet connection is provisioned for client group access in the CE router.

The firewall module also can define groups of servers 24 either at the remote subnetwork 16 or in the network cloud 20 and protect the server groups from the outside network with DMZ type services. Furthermore, in one preferred embodiment, a separate Ethernet interface on the CE router can be provisioned as a DMZ LAN.

In one preferred embodiment, the firewall module is configured to protect clients at a remote site that is connected to the Internet via a UniLink circuit. Preferably, a firewall is defined as the CE router that filters traffic between WAN, LAN and DMZ type environments.

Advantageously, inspection of a TCP packet stream by the firewall module passing through CE routers 10 can stop malicious TCP sessions. As mentioned previously, in one preferred embodiment, the firewall module maintains a record of the state of the connection and drops the data packet if the sequence numbers are not within an acceptable range.

Denial of service attacks that create large numbers of half-open sessions can also be mitigated by the firewall module. For example, in one preferred embodiment, the inspection process provided by the firewall module tracks session creation rates and the number of per destination host and per router half-open sessions. The firewall module can limit the number of half open sessions to a maximum. For example, newer sessions can remain while older sessions are dropped. In one preferred embodiment, an alert is issued by the firewall module if the number of half open sessions to a single host destination exceeds a predetermined number. In one preferred embodiment, a default value is initially set to 51 but can be adjusted based on customer requirements.

TCP pass-through protection can be done in either or both directions but preferably is configured in an outbound direction.

In one preferred embodiment, the firewall module defines a group of clients using a set of up to ten (10) Internet Protocol (IP) addresses or subnets. Preferably, no more than 10 entries are allowed in order to reduce administrative overhead and all IP addresses are located either in the customer cloud or in the remote subnetwork.

In one preferred embodiment, the firewall module provisions an inbound ACL at the outside network interface to deny traffic to the IP addresses of the protected clients. In addition, the firewall module restricts sessions permitted from the protected clients to the outside network by placing an inbound ACL on the protected side. Traffic to the outside network is preferably inspected and bypass entries for the return traffic are created. Protected clients are thus allowed to access applications on the outside network but the outside network preferably cannot access the clients.

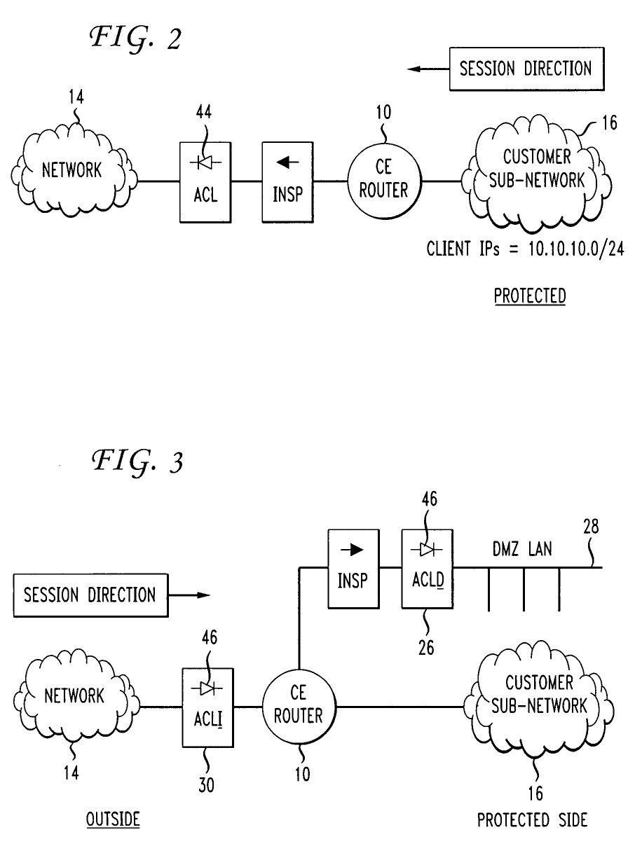

An example of one preferred embodiment is shown in connection with FIG. 2. In that example, the IP addresses of the protected clients are shown as 10.10.10.0/24. An inbound (from the outside network or Network Cloud) ACL is applied to block all inbound traffic to 10.10.10.0/24 while outbound traffic is not blocked. The diode symbol 44 shown in FIG. 2 shows the one-way feature of the session traffic. Inbound traffic to the router interface from clients on the protected side is inspected and an ACL bypass entry to allow return traffic is created by the firewall module.

By turning on generic inspection of UDP, the firewall module allows clients to access UDP applications, such as Domain Name System (DNS) which translates a computer's domain name into an IP address. By turning on ICMP inspection, the firewall module allows client devices, such as a computer, to query outside network hosts using utilities, such as Packet Internet Groper (Ping) which forwards data packets to check the quality of network connections and traceroute, which can locate a server that is slowing down transmissions on the Internet.

Preferably, the firewall traffic restricts client traffic by applying an inbound ACL to the router LAN interface. This operates to restrict clients to the services permitted by the ACL.

In one preferred embodiment, the router 10 logs messages indicating that the ACL drops a packet. This information can then be used to correlate these attempts with other security events.

In one preferred embodiment, server protection is provided by the firewall module by providing DMZ type services to a group of servers. As used herein, a server group is defined as either the servers on a DMZ LAN attached to the CE router or as a virtual DMZ. A virtual DMZ is a group of IP subnets or hosts that exist in the network cloud or in the remote subnetwork. Preferably, the CE monitors sessions from the outside network to the DMZ group. A DMZ LAN is a physically separate LAN on the CE with a single interface to the network.

In one preferred embodiment, the firewall module applies an inbound ACL on the protected side interface to deny traffic from the DMZ IP addresses. Preferably, an ACL is also applied inbound from the outside network to permit only requests for services permitted by the ACL. The firewall module then inspects traffic entering the DMZ and creates bypass entries for the return traffic in an outbound DMZ ACL. DMZs thus permit traffic to the host and return traffic to bypass the inbound ACL. As such, two features of the DMZ provide security. For virtual DMZ servers, if the server is compromised, the inbound (from virtual the DMZ) ACL prevents the compromised server from accessing the outside network. For DMZ LAN servers, if the server is compromised, the inbound (from DMZ LAN) ACL prevents the compromised server from accessing anything outside of the DMZ LAN.

Since DMZ servers do not usually create sessions with other servers or only create sessions to a small set of IP addresses, the attempt to create a session can be a strong indicator that the server has been compromised. In one preferred embodiment, the CE router sends a log message to the management center indicating that the ACL denied IP traffic from DMZ servers.

An example of a DMZ LAN implementation is shown in connection with FIG. 3. As shown in that example, an inbound ACL is applied at the DMZ interface, hereinafter referred to as ACLD 26, to block all traffic inbound from the DMZ 28. However traffic is permitted by an inbound ACL from the outside network, hereinafter referred to as ACLI 30, onto the DMZ 28. Outbound inspection is done at the DMZ interface by the firewall module of the router 10 to create an ACLD bypass entry to permit return traffic. The diode symbols 46 show the one way feature of the session traffic.

As the servers can be compromised, the system considers the DMZ 28 as being untrusted. If the servers are compromised, the ACLD 26 preferably prevents the server from attacking servers and clients outside of the DMZ LAN 28. Preferably, these attempts are logged to management center servers. By turning on ICMP inspection, the firewall module allows utilities, such as ping and traceroute, to be used from the outside network 14 to the DMZ.

In one preferred embodiment, Denial of Service (DoS) attack detection is performed by the firewall module on client sessions to a DMZ server. For example, if the number of client half-open sessions to a specific server passes a threshold value, the firewall module deletes old sessions when new sessions are requested to maintain the total number of sessions equal to the threshold value.

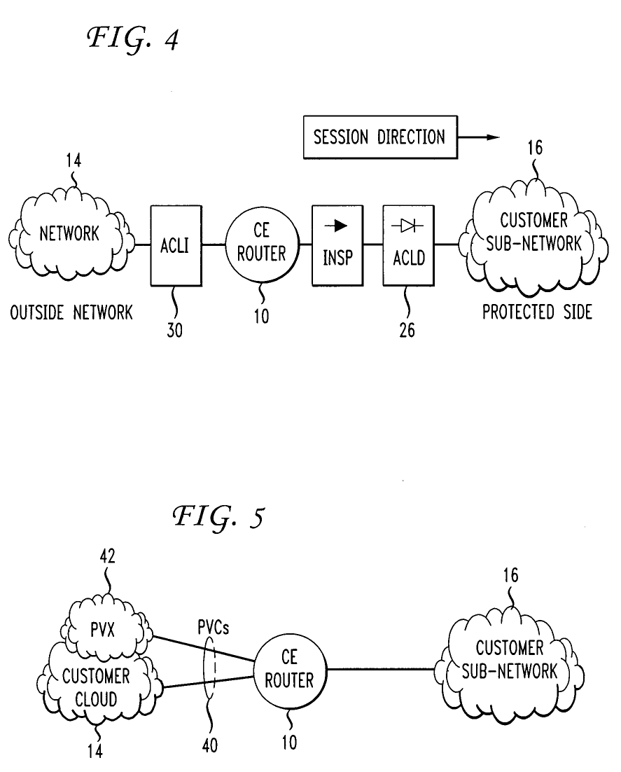

An example of a virtual DMZ embodiment is shown in connection with FIG. 4. As shown in FIG. 4, the firewall module applies an inbound ACLD 26 at the protected network interface to block all traffic inbound from virtual DMZ addresses. However, the firewall module permits traffic by ACLI 30 from the outside network onto the DMZ. The firewall module preferably performs outbound inspection at the protected network interface to create an ACLD bypass entry to permit return traffic.

If the servers are compromised, the ACLD 26 prevents the server from attacking servers and clients on the outside. As these attempts are also a strong indicator that the server has been compromised, the firewall module logs these attempts to management center servers.

Preferably, DoS attack detection is performed on client sessions to a virtual DMZ server. If the number of client half-open sessions to a specific server passes a threshold value, the firewall module deletes old sessions when new sessions are requested to maintain the total number of sessions equal to the threshold value.

In one preferred embodiment, UniLink service is provided by the firewall module. As mentioned previously, UniLink provisions separate logical channels on a single network port. In one preferred embodiment, UniLink provides an additional Private Virtual Circuit (PVC) on the CE to PE frame relay circuit for connection to the Internet. For example, as shown in FIG. 5, in one preferred embodiment, the managed firewall service router based WAN circuit becomes a frame relay Internet Permanent Virtual Connection type (PVX) 42, routes to the customer cloud 14 are added, and management is provided through the customer cloud 14.

Turning now to the Intrusion Prevention Services (IPS) module, the IPS module of the present invention examines data packets for signatures that indicate a malicious packet. When a match is detected, the IPS module preferably performs one or more of the following actions: generate an alarm message, drop the offending packet, reset the connection (if TCP) and drop the offending packet, create an ACL that denies all traffic from the IP address considered to be the source of the attack, as well as create an ACL that denies all traffic from the IP address that is considered the source of the attack belonging to the 5-tuple (src ip—the IP address of the computer attempting to establish communications, src port—the port number of the source (sending) computer, dst ip—the IP address of the destination for a communication attempt, dst port—the port number of the destination computer, and I4 communication protocol).

Preferably, the IPS module examines packets as they pass through a CE interface, which can be done either inbound or outbound. In some preferred embodiments, events can be configured to be active for a specified time period. The number of occurrences of a signature—a set of pre-defined characteristics associated with the packets, can also be configured for each signature before an alarm is sent. Preferably, signatures are stored locally on the router in a file the extension ‘.SDF’.

In one preferred embodiment, the IPS module is configured on the CE router since it is the gateway between the customer's network cloud and the remote subnet. Preferably, the IPS module is activated on the CE router for all traffic on either or both WAN or LAN side interfaces. For example, if all remote sites in the network are executing IPS modules then preferably, IPS modules are turned on in one direction. The inbound is preferred since traffic will be stopped before reaching the router.

In one preferred embodiment, the IPS module is configured such that data packets with signature matches result in one of the following two actions: 1) Alarm-Only, in which an alarm notification is generated; or 2) Alarm-drop/reset, in which the data packet is dropped and the session is reset if an alarm notification is generated.

Preferably, the IPS module sends all notifications as a syslog stream to an IP address specified in the intranet. In addition, in one preferred embodiment, the IPS module also sends the syslog stream to an e-mail notification server that sends an e-mail to one or more customer specified e-mail addresses with a copy to the management center.

Preferably, the IPS module sends alarms generated by signature matches as a syslog stream. In one preferred embodiment, the determination of which signatures generate an e-mail notification is user configurable.

For example, in one preferred embodiment, the action and notification for the signature is indicated by the IPS module using a severity parameter in the syslog message. Table 2 shows an exemplary mapping of the action and notification to the severity value in a syslog message and the severity value in a SDM (Security Device Manager) configuration tool.

TABLE 2
Severity to Action/Notification Mapping

| | SYSLOG | | E-MAIL |
|---|---|---|---|
| SDM VALUE | VALUE | ACTION | NOTIFICATION |
| Informational | 2 | Alarm Only | No |
| Low | 3 | Alarm Only | Yes |
| Medium | 4 | Alarm-Drop/reset | No |
| High | 5 | Alarm-Drop/reset | Yes |

Preferably, IPS signatures are stored in a file on the router and read into the router's memory when the IPS module is enabled on an interface. For example, in one preferred embodiment, the signature file contains signatures from the Cisco load file 256 MB.sdf and high confidence signatures that have a low false positive rate as determined by the MSS MIDS (Managed Intrusion Detection) development group.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A method of providing intranet client protection comprising:
connecting a subnetwork to an external network using a router, the subnetwork operatively coupling a client device to the external network, the subnetwork comprising a portion of an intranet; and
restricting access to the client device from the external network by the router in accordance with an access control list, the access control list identifying at least one service provided on the subnetwork.

2. The method of claim 1, wherein the external network comprises a wide area network.

3. The method of claim 1, further comprising:
inspecting a data packet from the a client device to the external network; and
allowing an inbound data packet from the external network to a client device based on the inspection.

4. The method of claim 3, further comprising dropping a data packet at the router based on the inspection.

5. The method of claim 1, further comprising:
determining a number of half-open active TCP sessions associated with the a client device;
comparing the number of half-open active TCP sessions to a threshold value; and
resetting at least one of the half-open sessions based on the comparison.

6. The method of claim 1, further comprising configuring the router for stateful inspection of outbound data packets to allow return traffic for at least one TCP session initiated by the client device.

7. The method of claim 1, further comprising providing notifications to one of a customer and service provider upon a device from the external network attempting to access the client device.

8. The method of claim 1, further comprising:
comparing a data packet to a digital signature representative of a malicious packet; and
generating an alarm based on the comparison.

9. The method of claim 8, further comprising performing the comparison on inbound and outbound data traffic.

10. The method of claim 1, wherein the external network is an IP/MPLS backbone network and the subnetwork is operatively connected to the backbone network using the router and an access circuit.

11. A system for providing intranet client protection comprising:
a subnetwork comprising a client device, the subnetwork comprising a portion of an intranet;
a router operatively coupling the subnetwork to an external network, the router restricting access to the at least one client device from the external network in accordance with an access control list, the access control list identifying at least one service provided on the subnetwork.

12. The system of claim 11, wherein the external network comprises a wide area network.

13. The system of claim 11, wherein the router inspects a data packet from the client device to the external network and allows an inbound data packet from the external network to the at least one client device based on the inspection.

14. The system of claim 13, wherein the router drops a data packet based on the inspection.

15. The system of claim 11, wherein the router determines a number of half-open active TCP sessions associated with the client device, compares the number to a threshold value, and resets at least one of the half-open sessions based on the comparison.

16. The system of claim 11, wherein the router is adapted for stateful inspection of outbound data packets to allow return traffic for at least one TCP session initiated by the client device.

17. The method of claim 1, wherein the router is adapted to provide notifications to one of a customer and service provider in response to a device from the external network attempting to access the client device.

18. The system of claim 11, wherein the router is adapted to compare a data packet to a digital signature representative of a malicious packet, and to generate an alarm based on the comparison.

19. The system of claim 18, wherein the router is adapted to perform the comparison on inbound and outbound data traffic.

20. The system of claim 1, wherein the external network is an IP/MPLS backbone network and the subnetwork is operatively connected to the backbone network using the router and an access circuit.
